(19) United States
(12) Patent Application Publication
(10) Pub. No.: US 2026/0312379 A1
(43) Pub. Date: Oct. 8, 2026

(54) Fish Tape Attachment Device

(71) Applicant: Isaiah Temple, Rio Rancho, NM (US)

(72) Inventor: Isaiah Temple, Rio Rancho, NM (US)

(21) Appl. No.: 19/342,796

(22) Filed: Sep. 29, 2025

Related U.S. Application Data
(60) Provisional application No. 63/783,532, filed on Apr. 4, 2025.

(51) Int. Cl. H02G 1/08

(52) U.S. Cl. CPC H02G 1/083

(57) ABSTRACT

A fish tape attachment device is provided. The device is designed to be attached to a fish tape or a push rod, wherein the device is comprised of a body shaped to minimize resistance, with an exterior surface having at least one ball bearing to reduce surface friction and enhance maneuverability of the device through a conduit. The device further comprises a chuck mechanism integrated within the body, which is cylindrical and concentrically positioned, and includes at least one tightening element and a rotatable collar that actuates the tightening element when rotated, securing an inserted rod or fish tape placed within the mechanism. Additionally, a cavity is positioned within the body to receive flat-profile fish tapes. A set screw is inserted through the body and cavity to apply a transverse clamping force on an inserted tape within the cavity.

### CROSS-REFERENCE TO RELATED APPLICATION

The present application claims priority to, and the benefit of, U.S. Provisional Application No. 63/783,532, which was filed on Apr. 4, 2025, and is incorporated herein by reference in its entirety.

### FIELD OF THE INVENTION

The present invention relates generally to the field of fish tapes. More specifically, the present invention relates to a device designed to be attached to a fish tape or push rod and comprises a body with at least one exterior ball bearing to reduce friction and improve maneuverability through a conduit once attached. The device further includes an integrated chuck mechanism with a rotatable collar for securing rods, as well as a cavity and set screw for securing flat-profile fish tapes. Accordingly, the present disclosure makes specific reference thereto. Nonetheless, it is to be appreciated that aspects of the present invention are also equally applicable to other like applications, devices, and methods of manufacture.

### BACKGROUND

The process of feeding fish tape through conduit systems is a fundamental task in electrical and communication cable installation. However, this process often encounters significant challenges due to internal obstructions within the conduit. These obstructions may include sharp directional changes, couplings, internal seams, surface irregularities, and debris, all of which can impede the forward motion of the fish tape. When such resistance occurs, it leads to considerable time delays, increases in labor costs, and the potential need for conduit disassembly or alternative routing methods. The fish tape can become snagged, kinked, or otherwise immobilized, complicating the wire-pulling process and increasing the risk of damage to the tape itself or the conduit interior. Furthermore, users are often forced to manipulate the tape manually in confined or elevated workspaces, which exacerbates the difficulty of navigating problematic conduit sections. Traditional fish tape ends are often blunt or minimally contoured, offering little support for negotiating complex pathways. As such, there remains a substantial and recurring problem in the field that demands a specialized solution to improve efficiency and reduce physical strain.

Therefore, there exists a long-felt need in the art for a fish tape attachment device that facilitates efficient operation of fish tape through conduit systems containing obstructions. There also exists a long-felt need in the art for a fish tape attachment device that minimizes resistance and reduces snagging within angular or debris-filled conduit sections. Moreover, there exists a long-felt need in the art for a fish tape attachment device that provides a secure and adaptable interface for various types of fish tapes and push rods.

The subject matter disclosed and claimed herein, in one embodiment thereof, comprises a fish tape attachment device. The device is designed to be attached to a fish tape or a push rod, wherein the device is comprised of a body shaped to minimize resistance, with an exterior surface having at least one ball bearing to reduce surface friction and enhance maneuverability of the device through a conduit. The device further comprises a chuck mechanism integrated within the body, which is cylindrical and concentrically positioned, and includes at least one tightening element and a rotatable collar that actuates the tightening element when rotated, securing an inserted rod or fish tape placed within the mechanism. Additionally, a cavity is positioned within the body to receive flat-profile fish tapes. A set screw is inserted through the body and cavity to apply a transverse clamping force on an inserted tape within the cavity.

In this manner, the fish tape attachment device of the present invention accomplishes all the foregoing objectives and provides a device that reduces snagging and resistance of fish tape and/or push rods within obstructed conduit paths, thereby addressing longstanding installation inefficiencies. More specifically, the integrated ball bearings reduce friction and facilitate smoother traversal, even through angular or debris-laden sections. The adaptable chuck mechanism provides secure interfacing with various push rods, while the internal cavity and clamping components enable reliable attachment of flat-profile fish tapes. These features collectively enable improved wire fishing performance, reduced installation time, and enhanced usability in challenging conduit environments, thereby resolving the problems associated with conventional fish tape feeding methods.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fish tape attachment device. The device is a fish tape and rod attachment designed to improve wire installation through conduit systems containing obstructions such as sharp angles, joints, or surface irregularities. The device enhances the navigation of fish tape through complex conduit paths by reducing friction and snagging.

The device is comprised of a body shaped to minimize resistance during conduit traversal. The exterior surface of the body is comprised of at least one ball bearing that may be retained in structures such as sockets, rotary housings, or raceways that allow omnidirectional rotation, enhancing maneuverability and reducing friction.

The device is configured to connect to fish tapes or push rods through an integrated chuck mechanism. The mechanism is cylindrical and concentrically located within the body and is comprised of at least one tightening element that conforms to the shape and diameter of the inserted rod or fish tape to provide secure attachment. A rotatable collar is positioned on the chuck mechanism and actuates the tightening element when rotated, applying a circumferential clamping force.

A cavity may also be present that is positioned within the body and configured to accept flat-profile fish tapes. The cavity is preferably rectangular in cross-section but may also be U-shaped, trapezoidal, or D-shaped, and is dimensioned to match common tape widths. A set screw intersects the cavity and is threaded through an opening in the body or collar. When tightened, the set screw applies transverse clamping force to secure a flat-profile fish tape.

A method of use is comprised of inserting a fish tape or push rod into the chuck mechanism and securing it using either the rotatable collar or set screw, depending on the type of insertion. Once secured, the device is introduced into the conduit system, where the shaped body and ball bearings facilitate reduced resistance and improved navigation through obstructed or angular conduit paths.

Accordingly, the fish tape attachment device of the present invention is particularly advantageous as it provides a device that reduces snagging and resistance of fish tape and/or push rods within obstructed conduit paths, thereby addressing longstanding installation inefficiencies. More specifically, the integrated ball bearings reduce friction and facilitate smoother traversal, even through angular or debris-laden sections. The adaptable chuck mechanism provides secure interfacing with various push rods, while the internal cavity and clamping components enable reliable attachment of flat-profile fish tapes. These features collectively enable improved wire fishing performance, reduced installation time, and enhanced usability in challenging conduit environments, thereby overcoming the limitations associated with existing fish tape, push rods, and feeding methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fish tape attachment device of the present invention in accordance with the disclosed architecture;

FIG. 2 illustrates a rear view of one potential embodiment of a fish tape attachment device of the present invention in accordance with the disclosed architecture;

FIG. 3 illustrates a perspective exploded view of one potential embodiment of a fish tape attachment device of the present invention in accordance with the disclosed architecture; and

FIG. 4 illustrates a flowchart of a method of using one potential embodiment of a fish tape attachment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fish tape attachment device that facilitates efficient operation of fish tape through conduit systems containing obstructions. There also exists a long-felt need in the art for a fish tape attachment device that minimizes resistance and reduces snagging within angular or debris-filled conduit sections. Moreover, there exists a long-felt need in the art for a fish tape attachment device that provides a secure and adaptable interface for various types of fish tapes and push rods.

The present invention, in one exemplary embodiment, is comprised of a fish tape attachment device. The device is designed to enhance wire installation within conduit systems that contain obstructions such as sharp angles, joints, or internal surface irregularities. By minimizing friction and snagging, the attachment improves the ability of fish tape to navigate complex conduit pathways more effectively.

The attachment is comprised of a body shaped to reduce resistance during movement through the conduit. The exterior surface of the body includes at least one ball bearing, which may be positioned in sockets, rotary housings, or raceways that support omnidirectional rotation. This configuration enhances maneuverability and further reduces surface friction.

An integrated chuck mechanism enables connection to fish tapes or push rods. The chuck mechanism is cylindrical, concentrically located within the body, and is comprised of at least one tightening element that conforms to the diameter and shape of the inserted fish tape or rod to establish a secure mechanical interface. A rotatable collar positioned on the chuck mechanism actuates the tightening element when rotated, applying a circumferential clamping force.

Within the body, a cavity may be included that is configured to receive flat-profile fish tapes. The cavity is preferably rectangular in cross-section, though alternative geometries such as U-shaped, trapezoidal, or D-shaped may also be used. The cavity is dimensioned to accommodate standard tape widths. A set screw intersects the cavity and is threaded through an opening in either the body or the collar. Tightening the set screw applies transverse clamping force to retain the flat-profile fish tape securely within the cavity.

A method of use involves inserting either a fish tape or push rod into the chuck mechanism and securing it by actuating the rotatable collar or tightening the set screw, depending on the insertion type. Once secured, the attachment is introduced into the conduit system, where the contoured body and external ball bearings reduce resistance and allow for smoother navigation through obstructed or angled segments.

As a result, the device provides a practical solution for minimizing snagging and resistance during wire fishing in obstructed conduit environments. The inclusion of integrated ball bearings decreases friction and allows for smoother passage through angular or debris-filled sections. The adaptable chuck mechanism securely interfaces with a range of push rods, while the cavity and clamping features ensure reliable retention of flat-profile fish tapes. These combined features improve wire installation efficiency, reduce overall installation time, and enhance usability in challenging conduit conditions, thereby addressing limitations associated with traditional fish tapes, push rods, and wire feeding methods.

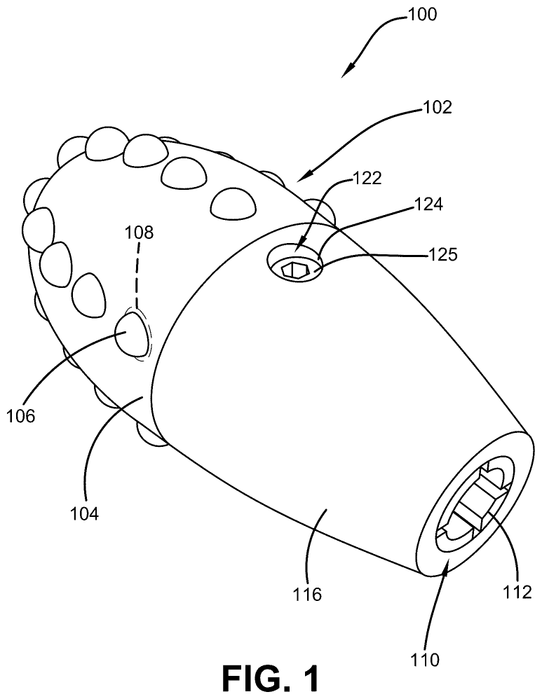

Referring initially to the drawings, FIG. 1 illustrates a perspective view of one potential embodiment of a fish tape attachment device 100 of the present invention in accordance with the disclosed architecture. The device 100 is a fish tape/rod attachment designed to facilitate efficient wire installation through conduit systems, particularly in environments containing obstructions such as but not limited to sharp angles, couplings, joints, debris, or internal surface irregularities. The device 100 addresses longstanding challenges associated with wire fishing by improving the ability of fish tape to navigate complex conduit paths with minimal friction and reduced risk of snagging.

The device 100 may be comprised of a body 102. The body 102 may be shaped to minimize resistance during traversal through the conduit. In one embodiment, the body 102 is egg-shaped with a contoured lead-in profile that reduces snagging on conduit transitions. However, the body 102 may be shaped in other geometries such as but not limited to any combination of spheroidal, teardrop, bullet-shaped, ellipsoidal, or oblate configurations, depending on specific conduit profiles and installation requirements.

An exterior surface 104 of the body 102 may be comprised of at least one ball bearing 106. In the preferred embodiment, the exterior surface 104 comprises a plurality of ball bearings 106 arranged in configurations such as but not limited to any combination of axial, radial, circumferential, or helical orientations, as seen in FIG. 1. The ball bearings 106 may be retained in receiving areas 108 (as seen in FIG. 1) such as but not limited to bearing sockets, rotary housings, or integrated raceways that permit omnidirectional rotation. The bearing configurations may reduce surface friction and enhance the maneuverability of the device 100 through angular or obstructed conduit sections. The number, size, material composition, and spacing of the ball bearings 106 may be selectively varied to correspond to conduit diameter, expected obstruction severity, and environmental conditions in different embodiments.

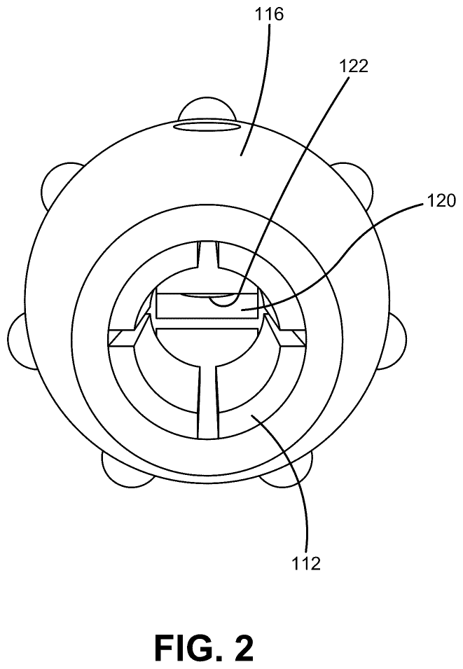

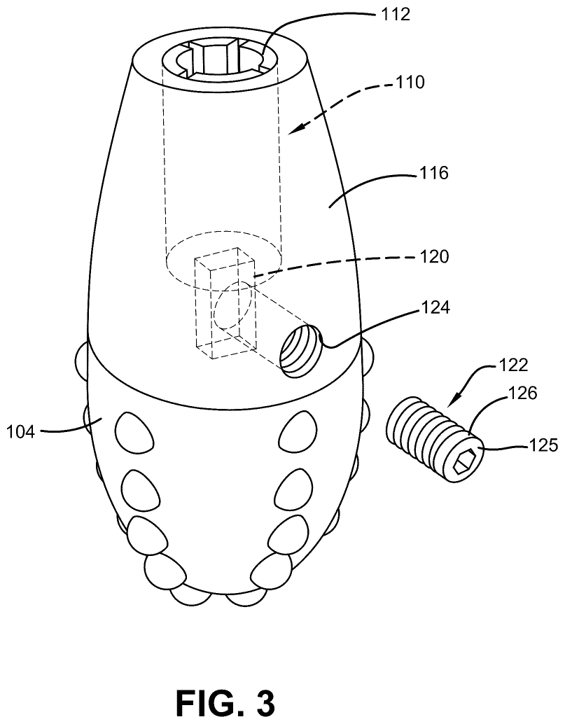

The device 100 may be configured to connect to various fish tapes and/or push rods via an integrated chuck mechanism 110. In one embodiment, the chuck mechanism 110 is cylindrical and positioned concentrically within the body 102, as seen in FIG. 3. The chuck mechanism 110 may be comprised of at least one tightening element 112, as seen in FIG. 1 and FIG. 2, such as but not limited to any combination of internal collets, segmented compression sleeves, elastomeric gripping elements, or spring-loaded jaws, that may dynamically conform to the diameter and surface profile of a rod or fish tape that has been inserted into the device 100, providing a secure mechanical interface.

The chuck mechanism 110 may further comprise a rotatable collar 116, as seen in FIG. 1. The collar 116 may actuate the tightening element 112 when rotated in a first direction, applying a circumferential clamping force around a rod and/or fish tape inserted into the chuck 110. In one configuration, the rotatable collar 116 is externally accessible and ergonomically contoured to permit manual actuation without requiring tools. The internal geometry of the chuck mechanism 110 may be varied to accommodate different rod cross-sections, surface textures, and materials including but not limited to fiberglass, steel, or polymeric composites.

Positioned within the body 102 and in communication with the chuck mechanism 110 is at least one cavity 120, as seen in FIG. 2 and FIG. 3. The cavity 120 may be shaped to accept flat-profile fish tapes and is preferably rectangular in cross-section. However, the cavity 120 may also be configured in other profiles such as but not limited to U-shaped, trapezoidal, or D-shaped, depending on fish tape geometry. The cavity 120 may be dimensioned to match common tape widths such as but not limited to ⅛″, 3/16″, or ¼″.

Intersecting the cavity 120 may be a set screw 122, which may be threaded through an opening 124 formed in the body 102 and/or the collar 116. When tightened, the set screw 122 may apply transverse clamping force to secure a flat-profile fish tape within the cavity 120. The set screw 122 may have any type of head 125 such as but not limited to slotted, Phillips, hex socket (Allen), Torx, square drive (Robertson), tri-wing, or spanner-type heads. The head 125 may be dimensioned to allow engagement with standard tools including but not limited to screwdrivers, hex keys, or socket drivers. In some embodiments, the head 125 may be comprised of an exterior surface 126 that is knurled or ridged to permit manual tightening without tools, enhancing ease of use in confined or overhead conduit installations.

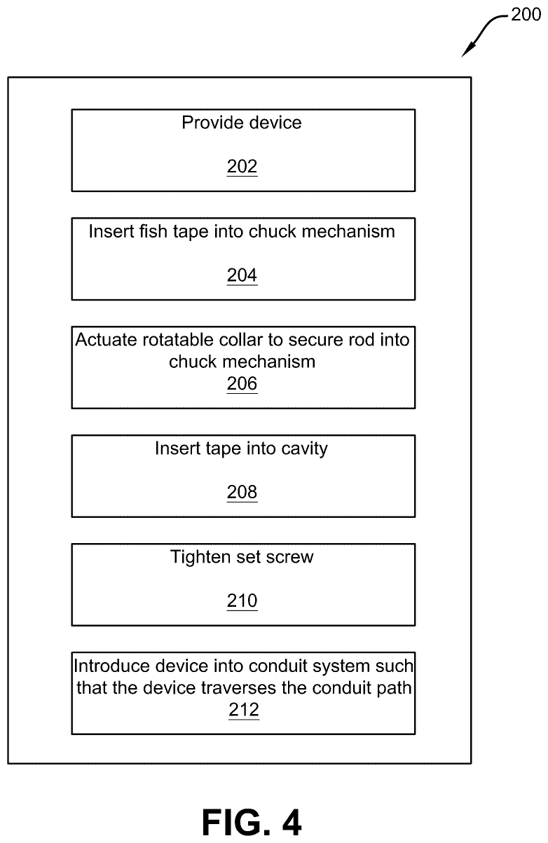

The present invention is also comprised of a method of using 200 the device 100, as seen in FIG. 4. First, a device 100 is provided comprised of a body 102, an exterior surface 104 comprising at least one ball bearing 106, a chuck mechanism 110 comprising at least one tightening element 112 and a rotatable collar 116, a cavity 120, and a set screw 122 with a head 125 and an exterior surface 126 [Step 202]. Then, a fish tape and/or push rod is inserted into the chuck mechanism 110 via an opening in the body 102 [Step 204]. Next, if a rod is placed within the chuck mechanism 110, the rotatable collar 116 is actuated in a first direction to engage the tightening element 112 and apply a circumferential clamping force around the inserted rod, thereby securing it within the chuck mechanism 110 [Step 206]. If a flat-profile fish tape is used, the tape is inserted into the cavity 120 positioned within the body 102 [Step 208]. Then, the set screw 122 is tightened via a head 125 to apply transverse clamping force and secure the flat-profile fish tape within the cavity 120 [Step 210]. Finally, regardless of whether a rod or a fish tape has been secured within the device 100, the device 100 can be introduced into a conduit system such that the body 102, aided by the plurality of ball bearings 106 on the exterior surface 104, traverses the conduit path while minimizing resistance, snagging, and friction at obstructions or bends [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fish tape attachment device” and “device” are interchangeable and refer to the fish tape attachment device 100 of the present invention.

Notwithstanding the foregoing, the fish tape attachment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fish tape attachment device 100 as shown in the FIGS. are for illustrative purposes only, and that many other sizes and shapes of the fish tape attachment device 100 are well within the scope of the present disclosure. Although the dimensions of the fish tape attachment device 100 are important design parameters for user convenience, the fish tape attachment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fish tape attachment device comprising:
a body comprised of an exterior surface comprising a ball bearing;
a chuck mechanism comprising a tightening element and a rotatable collar;
a cavity positioned within the body; and
a set screw intersecting the cavity.

2. The fish tape attachment device of claim 1, wherein the ball bearing is retained in a receiving area of the exterior surface.

3. The fish tape attachment device of claim 2, wherein the receiving area is comprised of a bearing socket, a rotary housing, or an integrated raceway.

4. The fish tape attachment device of claim 1, wherein the tightening element is comprised of an internal collet, a segmented compression sleeve, an elastomeric gripping element, or a spring-loaded jaw.

5. The fish tape attachment device of claim 1, wherein the cavity is comprised of a rectangular cavity.

6. The fish tape attachment device of claim 1, wherein the set screw is comprised of a head.

7. The fish tape attachment device of claim 6, wherein the head is comprised of a slotted head, a Phillips head, a hex socket head, a torx head, a square drive head, a tri-wing head, or a spanner-type head.

8. The fish tape attachment device of claim 6, wherein the head is comprised of an exterior surface.

9. The fish tape attachment device of claim 8, wherein the exterior surface is comprised of a texture.

10. A fish tape attachment device comprising:
a body comprised of an exterior surface comprising a ball bearing;
a chuck mechanism comprising a tightening element and a rotatable collar;
a cavity positioned within the body in communication with the chuck mechanism; and
a set screw intersecting the cavity.

11. The fish tape attachment device of claim 10, wherein the ball bearing is retained in a receiving area of the exterior surface.

12. The fish tape attachment device of claim 11, wherein the receiving area is comprised of a bearing socket, a rotary housing, or an integrated raceway.

13. The fish tape attachment device of claim 10, wherein the tightening element is comprised of an internal collet, a segmented compression sleeve, an elastomeric gripping element, or a spring-loaded jaw.

14. The fish tape attachment device of claim 10, wherein the cavity is comprised of a rectangular cavity.

15. The fish tape attachment device of claim 10, wherein the set screw is comprised of a head.

16. The fish tape attachment device of claim 15, wherein the head is comprised of a slotted head, a Phillips head, a hex socket head, a torx head, a square drive head, a tri-wing head, or a spanner-type head.

17. The fish tape attachment device of claim 15, wherein the head is comprised of an exterior surface.

18. The fish tape attachment device of claim 15, wherein the exterior surface is comprised of a texture.

19. The fish tape attachment device of claim 18, wherein the texture is comprised of a knurled texture or a ridged texture.

20. A method of using a fish tape attachment device, the method comprising the following steps:
providing a fish tape attachment device comprised of a body, an exterior surface comprising a ball bearing, a chuck mechanism comprising a tightening element and a rotatable collar, a cavity, and a set screw;
inserting a fish tape or a push rod into the chuck mechanism;
actuating the rotatable collar in a first direction to engage the tightening element and apply a circumferential clamping force around the push rod, thereby securing the push rod within the chuck mechanism;
inserting a flat-profile fish tape into the cavity;
tightening the set screw to apply transverse clamping force and secure the flat-profile fish tape within the cavity; and
introducing the device into a conduit such that the body traverses a path of the conduit aided by the ball bearing.
